(19) United States
(12) Patent Application Publication
(10) Pub. No.: US 2010/0062963 A1
(43) Pub. Date: Mar. 11, 2010

(54) DETERGENT COMPOSITION

(75) Inventors: Takanori Kotera, Wakayama-shi (JP); Nobuyoshi Yamaguchi, Wakayama-shi (JP)

Correspondence Address: BIRCH STEWART KOLASCH & BIRCH, PO BOX 747, FALLS CHURCH, VA, 22040-0747, US

(73) Assignee: Kao Corporation, Tokyo (JP)

(21) Appl. No.: 12/516,520

(22) PCT Filed: Dec. 27, 2007
(86) PCT No.: PCT/JP2007/075405

§ 371 Date: May 27, 2009

(30) Foreign Application Priority Data
Dec. 28, 2006 (JP) 2006 356036
Dec. 28, 2006 (JP) 2006 356037

(51) Int. Cl. C11D 3/395

(52) U.S. Cl. 510/312

(57) ABSTRACT

Disclosed is the detergent composition containing (a) an inorganic peroxide; (b) a specific phenylester-type bleaching activator; and (1d) a polyglyceryl alkyl ether having an alkyl group of 4 to 20 carbon atoms in an amount of more than 5% by mass to 35% by mass, or the detergent composition containing (a) an inorganic peroxide; (b) a specific phenylester-type bleaching activator; (2d) a polyglyceryl alkyl ether having an alkyl group of 4 to 20 carbon atoms; and, (e) a fatty acid or a salt thereof.

### FIELD OF THE INVENTION

The present invention relates to a detergent composition.

### BACKGROUND OF THE INVENTION

To improve washing performances, there has been a proposed method of adding a bleaching activator to a detergent composition containing an inorganic peroxide to generate an organic peracid in washing. For example, JP-A2004-210903 discloses a solid bleaching agent containing hydrogen peroxide to which a bleaching activator can be added.

### SUMMARY OF THE INVENTION

The present invention (I) is a detergent composition containing: (a) an inorganic peroxide (hereinafter, referred to as the component (a)); (b) a phenylester-type bleaching activator having a group selected from —COOM, —SO₃M and —OSO₃M (M represents a cation) and a hydrocarbon of 5 to 20 carbon atoms in a molecule (hereinafter, referred to as the component (b)); and (1d) a polyglyceryl alkyl ether having an alkyl group of 4 to 20 carbon atoms (hereinafter, referred to as the component (1d)) in an amount of more than 5% by mass to 35% by mass.

The present invention (II) is a detergent composition containing: (a) an inorganic peroxide (hereinafter, referred to as the component (a)); (b) a phenylester-type bleaching activator having a group selected from —COOM, —SO₃M and —OSO₃M (M represents a cation) and a hydrocarbon of 5 to 20 carbon atoms in a molecule (hereinafter, referred to as the component (b)); (2d) a polyglyceryl alkyl ether having an alkyl group of 4 to 20 carbon atoms (hereinafter, referred to as the component (2d)); and, (e) a fatty acid or a salt thereof (hereinafter, referred to as the component (e)).

### DETAILED DESCRIPTION OF THE INVENTION

Nonionic surfactants having oxyalkylene groups (also referred to as an oxyalkanyl group; Hereinafter, used is the oxyalkylene group) such as an oxyethylene group generally have high washing performances, and thus are widely used in detergent compositions. However, it has been found that in a detergent composition containing a nonionic surfactant having an oxyalkylene group, a reaction between an inorganic peroxide and a bleaching activator is inhibited, and an effect of improving washing performances by an organic peracid is dramatically reduced.

The present invention intends to provide a detergent composition efficiently generating an organic peracid and having excellent bleaching properties, particularly a detergent composition containing a nonionic surfactant having an oxyalkylene group.

According to the present invention, a detergent composition efficiently generating an organic peracid and having excellent bleaching properties is provided.

<Component (a)>

The inorganic peroxide of component (a) is a substance generating hydrogen peroxide in water, including percabonates such as sodium percarbonate and perborates such as sodium perborate, for example. The detergent composition of the present invention contains the component (a) in an amount of preferably 0.1 to 60% by mass, more preferably 0.5 to 40% by mass, even more preferably 1 to 20% by mass, and even more preferably 2 to 15%.

<Component (b)>

In order to improve bleaching effects, the detergent composition of the present invention contains the phenylester-type (alkanoyloxybenzene-type or alkyloxycarbonyloxybenzene-type) bleaching activator of the component (b), having a group selected from —COOM, —SO₃M and —OSO₃M (M represents a cation) and a hydrocarbon of 5 to 20 carbon atoms in a molecule.

The component (b) is preferably the bleaching activator represented by the following formula (b1).

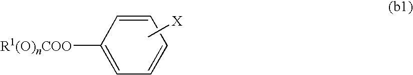

(wherein, R¹ represents a hydrocarbon group of 5 to 20 carbon atoms; “n” represents a number of 1 or 0; and, X represents —COOM, —SO₃M or —OSO₃M, M represents a cation.)

The component (b) is particularly preferably an alkanoyloxybenzenesulfonic or alkanoyloxybenzenecarboxylic acid having an alkanoyl group of 8 to 14 carbon atoms and more preferably 8 to 13 carbon atoms, respectively, or a salt thereof.

Specific examples of the component (b) include octanoyloxy-p-benzenesulfonic acid, nonanoyloxy-p-benzenesulfonic acid, 3,5,5-trimethylhexanoyloxy-p-benzenesulfonic acid, decanoyloxy-p-benzenesulfonic acid, dodecanoyloxy-p-benzenesulfonic acid, octanoyloxy-o- or -p-benzenecarboxylic acid, nonanoyloxy-o- or -p-benzenecarboxylic acid, 3,5,5-trimethylhexanoyloxy-o- or -p-benzenecarboxylic acid, decanoyloxy-o- or -p-benzenecarboxylic acid, dodecanoyloxy-o- or -p-benzenecarboxylic acid, and salts thereof. Preferable examples of the salt include sodium salt, potassium salt and magnesium salt. From the point of solubility, sodium salts are particularly preferred.

Among them, from the point of bleaching effects, particularly preferred are nonanoyloxy-p-benzenesulfonic acid, decanoyloxy-p-benzenecarboxylic acid, dodecanoyloxy-p-benzenesulfonic acid and salts thereof.

The detergent composition of the present invention contains the component (b) in an amount of preferably 0.01 to 20% by mass, more preferably 0.05 to 10% by mass, and even more preferably 0.1 to 4% by mass.

<Component (c)>

The detergent composition of the present invention can contain a nonionic surfactant of the component (c), having an alkoxylate group in a molecule. The component (c) is preferably the compound represented by the following formula (c1).

R¹¹-T-[(R¹²O)ₐ—H]_{b} (c1)

(wherein, R¹¹ represents an alkyl or alkenyl group of 7 to 18 carbon atoms, and preferably 10 to 16 carbon atoms; R¹² represents an alkylene group of 2 or 3 carbon atoms, and preferably an ethylene group; “a” represents a number of 2 to 20, preferably 4 to 10, and even more preferably 5 to 8; T represents —O—, —CON— or —N—; and, “b” is 1 when T represents —O—, or “b” is 2 when T represents —CON— or —N—.)

Specific examples of the compound represented by the formula (c1) include the following compound.

R¹¹—O—(C₂H₄O)_{c}—H (c1-1)

(wherein, R¹¹ represents the same meaning as above; and, “c” represents a number of 2 to 20, preferably 4 to 12, and even more preferably 6 to 10.)

R¹¹—O—(C₂H₄O)_{d}—(C₃H₆O)ₑ—H (c1-2)

(wherein, R¹¹ represents the same meaning as above; “d” and “e” each independently represent a number of 2 to 15, and preferably 2 to 10; and, the compound may be a random or block copolymer of ethylene oxide and propylene oxide.)

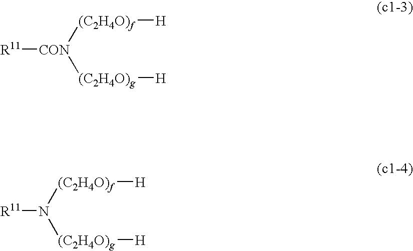

(wherein, R¹¹ represents the same meaning as above; and, the sum in total of the numbers of “f” and “g” is 3 to 20, preferably 3 to 15, and even more preferably 2 to 10.)

In the present invention, among them, nonionic surfactants selected from (c1-1) and (c1-2) are particularly preferred.

The detergent composition of the present invention contains the component (c) in an amount of preferably 5 to 35% by mass, more preferably 5 to 20% by mass, and even more preferably 10 to 15% by mass.

The present invention (I) includes (1d), and the present invention (II) includes (2d). These will be described below, respectively.

<Component (1d)>

The component (1d) is a polyglyceryl alkyl ether having an alkyl group of 4 to 20 carbon atoms, preferably a polyglyceryl alkyl ether having an alkyl group of 4 to 9 carbon atoms, and particularly preferably the polyglyceryl alkyl ether represented by the following formula (1d1).

R—O—(C₃H₆O₂)ₙ—H (1d1)

(wherein, R represents an alkyl group of 4 to 9 carbon atoms; and, “n” represents a condensation degree of glycerin, which is a number of 1 to 10, preferably 2 to 7, and more preferably 3 to 5, on the average.)

The detergent composition of the present invention (I) contains the ingredient (1d) in an amount of more than 5% by mass to 35% by mass, preferably more than 5% by mass to 25% by mass, and more preferably more than 5% by mass to 20% by mass.

In the detergent composition of the present invention (I) containing the component (c), a mass ratio represented by (c)/(1d) of ingredients (c) to (1d) is preferably 1000/1 to 1/50, more preferably 1000/1 to 1/5, even more preferably 500/1 to 1/1, and even more preferably 10/1 to 1/1, from the viewpoint of increasing a generation rate of an organic peracid.

<Component (2d)>

The component (2d) is a polyglyceryl alkyl ether having an alkyl group of 4 to 20 carbon atoms, preferably a polyglyceryl alkyl ether having an alkyl group of 6 to 20 carbon atoms, and particularly preferably the polyglyceryl alkyl ether represented by the following formula (2d1).

R—O—(C₃H₆O₂)ₙ—H (2d1)

(wherein, R represents an alkyl group of 6 to 20 carbon atoms: and, “n” represents a condensation degree of glycerin, which is a number of 1 to 10, preferably 2 to 7, and more preferably 3 to 5, on the average.)

The detergent composition of the present invention (II) contains the component (2d) in an amount of preferably 0.1 to 5% by mass, and more preferably 0.1 to 3% by mass.

In the detergent composition of the present invention (II) containing the component (c), a mass ratio represented by (c)/(2d) of ingredients (c) to (2d) is preferably 1000/1 to 1/50, more preferably 1000/1 to 1/5, even more preferably 500/1 to 1/1, and even more preferably 10/1 to 1/1, from the viewpoint of increasing a generation rate of an organic peracid.

<Component (e)>

Examples of the fatty acid or its salt of the component (e) include myristic acid, sodium myristate, potassium myristate, palmitic acid, sodium palmitate, potassium palmitate, stearic acid, sodium stearate, potassium stearate, oleic acid, sodium oleate, potassium oleate, linoleic acid, sodium linoleate, potassium linoleate, linolenic acid, linolenic acid sodium salt, and linolenic acid potassium salt. Among them, preferred are sodium myristate, sodium palmitate, sodium stearate and sodium oleate.

Addition of the component (e) enables to increase a generation rate of organic peracid with smaller amount of the component (2d).

The detergent composition of the present invention preferably contains the component (e) in an amount of 0.01 to 20% by mass, and more preferably 0.1 to 5% by mass.

<Other Components>

The detergent composition of the present invention (I) preferably contains an anionic surfactant (hereinafter, referred to as the component (1f)).

The detergent composition of the present invention (II) preferably contains an anionic surfactant other than the component (e) (hereinafter, referred to as the component (2f)).

The anionic surfactant preferably has an alkyl or alkenyl group of 10 to 18 carbon atoms, preferably 10 to 16 carbon atoms, and even more preferably 10 to 15 carbon atoms and a —SO₃M group and/or a —OSO₃M group (M: counter ion). Specific examples of the anionic surfactant include alkylbenzenesulfonic acids, alkyl- (or alkenyl-) sulfuric acid esters, polyoxyalkylene alkyl (or alkenyl) ether sulfuric acid esters having average addition mole numbers of alkylene oxide of 1 to 6, olefin sulfonic acids, alkanesulfonic acids, α-sulfofatty acids, α-sulfofatty acid esters, and salts thereof, have the carbon atom number as described above. Among them, at least one selected from alkyl- (or alkenyl-) sulfuric acid esters having an alkyl or alkenyl group of 10 to 16 carbon atoms, polyoxyethylene alkyl (or alkenyl) ether sulfuric acid esters having an alkyl or alkenyl group of 10 to 16 carbon atoms and having an average addition mole numbers of ethylene oxide (hereinafter, referred to as EO) of 1 to 6, preferably 1 to 4, and even more preferably 1 to 3, alkylbenzenesulfonic acids having 10 to 15 carbon atoms and salts thereof is particularly preferably used. Preferred salts are sodium salt, potassium salt, ammonium salt and alkanolamine salt from the point of storage stability.

The detergent composition of the present invention preferably contains the ingredient (1f) or (2f) in an amount of 5 to 35% by mass, and more preferably 5 to 20% by mass.

The detergent composition of the present invention preferably contains an alkali agent. Examples of the alkali agent include carbonates, bicarbonates, silicates, orthosilicates, metasilicates, crystalline silicates and phosphates. Preferred examples of the salt include alkaline metal salts such as sodium salt and potassium salt. These alkali agents may be used alone or as a mixture of two or more of them. Specific examples of the alkali agent include sodium carbonate, potassium carbonate, sodium hydrogen carbonate, sodium silicate JIS No. 1, sodium silicate JIS No. 2, sodium silicate JIS No. 3, sodium tetraborate, sodium pyrophosphate, and sodium tripolyphosphate. As used herein, a crystalline silicate refers an alkali substance having a maximum pH of 11 or more when dispersed in ion-exchanged water by 0.1% by mass at 20° C. and requiring 5 ml or more of 0.1 N aqueous HCl to reduce pH of 1 L of the dispersion to 10, and is distinguished from a zeolite (crystalline aluminosilicate). The crystalline silicate is preferably lamellar. Those can be used, for example, described in JP-A7-89712, JP-A60-227895, Phys. Chem. Glasses. 7,p 127-p 138 (1966), and Z. Kristallogr., 129, p 396-p 404 (1969). A crystalline silicate represented by 0.42Na₂O.0.14K₂O.SiO₂.0.03CaO.0.0005MgO is preferably used.

Crystalline silicate powders and granules are also commercially available from Hoechst under the trade name “Na-SKS-6” (δ-Na₂Si₂O₅).

The detergent composition of the present invention may also contain a silicate compound (other than the alkali agent) widely used as a detergent builder. Examples of the silicate compound include crystalline aluminosilicates or amorphous aluminosilicates and silicates. Among them, zeolites are preferred.

The zeolite is preferably a compound represented by the formula (c1), and more preferably a compound represented by the formula (c2).

a (M₂O).Al₂O₃.b(SiO₂).w(H₂O) (c1)

(wherein, M represents an alkaline metal atom; “a” , “b” and “w” each represent a molar ratio of components, which are generally 1.5≧a≧0.7, 6≧b≧0.8, and “w” is the arbitrary positive number.)

Na₂O.Al₂O₃.n(SO₂).m(H₂O) (c2)

(wherein, “n” represents a number of 1.8 to 3; and “m” represents a number of 1 to 6.)

Examples of the zeolite include synthetic zeolites including zeolite A, zeolite X and zeolite P. The zeolite preferably has an average particle diameter of 0.1 to 10 □m. The detergent composition of the present invention preferably contains the zeolite in an amount of 1 to 90% by mass, more preferably 5 to 50% by mass, and even more preferably 10 to 40% by mass.

The detergent composition of the present invention may contain a sequestering agent. Examples of the sequestering agent include: (1) a phosphoric compound selected from phosphoric acid, tripolyphosphoric acid and phytic acid; (2) a phosphonic acid selected from ethane-1,1-diphosphonic acid, ethane-1,1,2-triphosphonic acid, ethane-1-hydroxy-1,1-diphosphonic acid, ethanehydroxy-1,1,2-triphosphonic acid, ethane-1,2-dicarboxy-1,2-diphosphonic acid and methanehydroxyphosphonic acid; (3) a phosphonocarboxylic acid selected from 2-phosphonobutane-1,2-dicarboxylic acid, 1-phosphonobutane-2,3,4-tricarboxylic acid and α-methylphosphonosuccinic acid; (4) an amino acid selected from aspartic acid, glutamic acid and glycine; (5) an aminopolyacetic acid selected from nitrilotriacetic acid, iminodiacetic acid, ethylenediaminetetraacetic acid, diethylenetriaminepentaacetic acid, glycol ether diaminetetraacetic acid, hydroxyethyliminodiacetic acid, triethylenetetraminehexaacetic acid and djenkolic acid; (6) an organic acid selected from diglycolic acid, oxydisuccinic acid, carboxymethyloxysuccinic acid, citric acid, lactic acid, tartaric acid, oxalic acid, malic acid, oxydisuccinic acid, gluconic acid, carboxymethyl succinic acid and carboxymethyl tartaric acid; and (7) an aminopoly(methylenephosphonic acid) or polyethylene polyamine poly(methylenephosphonic acid). Preferred are the phosphonic acid compound (2), the aminopolyacetic acid (5), the organic acid (6) and the compound (7). In the present invention, particularly preferred is a compound selected from ethane-1,1-diphosphonic acid, ethane-1,1,2-triphosphonic acid, ethane-1-hydroxy-1,1-diphosphonic acid, citric acid, ethylenediaminetetraacetic acid, diethylenetriaminepentaacetic acid, ethylenediaminediacetic acid and 2- hydroxyethyliminodiacetic acid. The detergent composition of the present invention preferably contains the sequestering agent in an amount of 0.01 to 10% by mass, and more preferably 0.1 to 5% by mass.

The detergent composition of the present invention may contain additives such as an anti-resoiling agent (e.g., carboxy methyl cellulose), a softener (e.g., a dialkyl type quaternary ammonium salt and clay mineral), a reductant (e.g., a sulfite), a fluorescent bleaching agent (e.g., a biphenyl and an aminostilbene types), a foam-controlling agent (e.g., silicone), a fragrance and an enzyme (e.g., protease, cellulase, pectinase, amylase and lipase).

The present invention may include the following organic builders, with the proviso that the present invention (II) may include the following organic builders other than the component (e). Preferred examples of the organic builder include carboxylates (aminocarboxylates, hydroxyaminocarboxylates, hydroxycarboxylates, cyclocarboxylates, maleic acid derivatives, oxalates and the like) and organic carboxylic acid (salt) polymers (acrylic acid polymers and copolymers, polyhydric carboxylic acid polymers and copolymers, glyoxylic acid polymers, polysaccharides, salts thereof and the like). Among them, preferred are organic carboxylic acid (salt) polymers. In salts of these builders, preferred counter ions are alkaline metal salts and amines. Among them, sodium and/or potassium, monoethanolamine, and diethanolamine are more preferred. These builders may be used alone or in combination of two or more of them.

From the viewpoints of fluidity and caking resistance when the composition is in the state of powder or granule, the surface of the composition may be modified. A zeolite can be used as a surface modifier. Examples of the other surface modifier include silicate compounds such as calcium silicate, silicon dioxide, bentonite, talc, clay and amorphous silica derivatives; pulverized powders of metallic soap, powder surfactants and the like; and water-soluble polymers such as carboxy methyl cellulose, polyethylene glycol, sodium polyacrylate, copolymers of acrylic acid and maleic acid and salts thereof. More preferably used is a zeolite.

When the detergent composition of the present invention is powdery, a volume density thereof is preferably 300 to 1000 g/L, more preferably 500 to 900 g/L, and even more preferably 600 to 800 g/L. An average particle diameter thereof is preferably 150 to 3000 more preferably 500 to 1500 μm, and even more preferably 600 to 1200 μm.

The detergent composition of the present invention is preferably used for textile products such as cloths and bedclothes.

### Examples

The following Examples demonstrate the present invention. Examples are intended to illustrate the present invention and not to limit the present invention.

Detergent compositions shown in Tables 1 and 2 were prepared with ingredients as shown in Tables 1 and 2, and evaluated for a generation rate of organic peracid and a detergency by means of the method described below. Results are shown in Tables 1 and 2.

### <Method for Measuring a Generation Rate of Organic Peracid>

To 1 L of ion-exchanged water was added 0.6667 g of detergent composition, and stirred for 10 minutes with a magnetic stirrer. To this was added 1 mL of aqueous 1% catalase solution and stirred for three minutes. Then, to this was added 10 mL of 20% sulfuric acid and 10 mL of aqueous 10% potassium iodide solution to develop yellow color. The mixture was titrated with 1/50 N sodium thiosulfate to the disappearance of the yellow color. A generation rate of organic peracid (%) was calculated according to the following formula.

$$( \begin{matrix}generation rate of \\ organic peracid ( \% )\end{matrix} ) = \frac{\begin{matrix}( 1 / 50 ) \times \\ ( \begin{matrix}Amount of sodium thiosulfate \\ required for titration ( L )\end{matrix} ) \times 0.5\end{matrix}}{\begin{matrix}amount of bleaching \\ activator added ( mol )\end{matrix}} \times 100$$

<Detergency>

To 1 L each of tap water were added 0.6667 g each of detergent compositions shown in Tables 1 and 2 and dissolved. Then to these each were added five pieces of cloth stained with spinach, which was prepared as described below, and washed for 10 minutes with a Terg-O-Tometer at 80 round/min. Test pieces were sufficiently rinsed and dried. A washing rate was determined according to the following formula.

washing rate (%)=(reflectance after washing-reflectance before washing)/(reflectance of clean cloth-reflectance before washing)×100

A reflectance was measured using NDR-10DP manufactured by Nippon Denshoku Industries Co., Ltd. with a 460 nm filter.

Preparation of Cloth Stained with Spinach

Commercially available spinach was pureed with a blender. A liquid part of the puree was filtered through cotton cloth. 0.5 g of the resultant liquid was uniformly applied on 6 cm by 6 cm of cotton test cloth #2023, and dried for 12 hours at room temperature. The dried cloth was used in the test.

TABLE 1

| | | | Example | | | | |
|---|---|---|---|---|---|---|---|
| | | | 1-1 | 1-2 | 1-3 | 1-4 | 1-5 |
| Compounding | (a) | sodium percarbonate | 15 | 15 | 15 | 15 | 15 |
| component | (b) | dodecanoyloxy-p-benzenesulfonic acid sodium salt | 0.8 | 0.8 | 0.8 | 0.8 | 0.8 |
| (% by mass) | (c) | polyoxyethylene dodecyl ether (average addition mole number of | 10 | 10 | 10 | 10 | 10 |
| | | EO: 6) | | | | | |
| | (1d) | polyglycerin hexyl ether (average glycerol condensation degree: | 7 | 10 | 20 | 7 | 10 |
| | | 3) | | | | | |
| | (1f) | laurylbenzenesulfonic acid sodium salt | 0 | 0 | 0 | 10 | 10 |
| | Others | sodium carbonate | 20 | 20 | 20 | 20 | 20 |
| | | Zeolite | 15 | 15 | 15 | 15 | 15 |
| | | sodium sulfate | balancce | balancce | balancce | balancce | balancce |
| | the total | | 100 | 100 | 100 | 100 | 100 |
| generation rate of organic peracid (%) | | | 54 | 62 | 65 | 60 | 67 |
| detergency (%) | | | 72 | 75 | 79 | 78 | 83 |
| | | | Example | Comparative example | | | |
| | | | 1-6 | 1-1 | 1-2 | 1-3 | 1-4 |
| Compounding | (a) | sodium percarbonate | 15 | 15 | 15 | 15 | 15 |
| component | (b) | dodecanoyloxy-p-benzenesulfonic acid sodium salt | 0.8 | 0.8 | 0.8 | 0.8 | 0.8 |
| (% by mass) | (c) | polyoxyethylene dodecyl ether (average addition mole number of | 10 | 10 | 10 | 10 | 10 |
| | | EO: 6) | | | | | |
| | (1d) | polyglycerin hexyl ether (average glycerol condensation degree: | 20 | 0 | 3 | 0 | 3 |
| | | 3) | | | | | |
| | (1f) | laurylbenzenesulfonic acid sodium salt | 10 | 0 | 0 | 10 | 10 |
| | Others | sodium carbonate | 20 | 20 | 20 | 20 | 20 |
| | | Zeolite | 15 | 15 | 15 | 15 | 15 |
| | | sodium sulfate | balancce | balancce | balancce | balancce | balancce |

| | | | | | |
|---|---|---|---|---|---|
| the total | 100 | 100 | 100 | 100 | 100 |

| | | | | | |
|---|---|---|---|---|---|
| generation rate of organic peracid (%) | 80 | 0 | 10 | 0 | 12 |
| detergency (%) | 90 | 30 | 32 | 42 | 43 |

TABLE 2

| | | | Example | | | | |
|---|---|---|---|---|---|---|---|
| | | | 2-1 | 2-2 | 2-3 | 2-4 | 2-5 |
| Compounding | (a) | sodium percarbonate | 15 | 15 | 15 | 15 | 15 |
| component | (b) | Dodecanoyloxy-p-benzenesulfonic acid sodium salt | 0.8 | 0.8 | 0.8 | 0.8 | 0.8 |
| (% by mass) | (c) | Polyoxyethylene dodecyl ether (average addition mole number | 10 | 10 | 10 | 10 | 10 |
| | | of EO: 6) | | | | | |
| | (2d) | Polyglycerin hexyl ether (average glycerol condensation degree: | 0.2 | 1 | 3 | 0 | 0 |
| | | 3) | | | | | |
| | | Polyglycerin dodecyl ether (average glycerol condensation | 0 | 0 | 0 | 0.2 | 1 |
| | | degree: 3) | | | | | |
| | (e) | Sodium palmitate | 2 | 2 | 2 | 2 | 2 |
| | (2f) | Laurylbenzenesulfonic acid sodium salt | 10 | 10 | 10 | 10 | 10 |
| | Others | Sodium carbonate | 20 | 20 | 20 | 20 | 20 |
| | | zeolite | 15 | 15 | 15 | 15 | 15 |
| | | Sodium sulfate | balance | balance | balance | balance | balance |

| | | | | | |
|---|---|---|---|---|---|
| the total | 100 | 100 | 100 | 100 | 100 |

| | | | | | |
|---|---|---|---|---|---|
| Generation rate of organic peracid (%) | 65 | 70 | 72 | 64 | 70 |
| detergency (%) | 83 | 85 | 86 | 83 | 86 |

| | | | Example | Comparativee example | | |
|---|---|---|---|---|---|---|
| | | | 2-6 | 2-1 | 2-2 | 2-3 |
| Compounding | (a) | sodium percarbonate | 15 | 15 | 15 | 15 |
| component | (b) | Dodecanoyloxy-p-benzenesulfonic acid sodium salt | 0.8 | 0.8 | 0.8 | 0.8 |
| (% by mass) | (c) | Polyoxyethylene dodecyl ether (average addition mole number of EO: 6) | 10 | 0 | 0 | 0 |
| | (2d) | Polyglycerin hexyl ether (average glycerol condensation degree: 3) | 0 | 0.2 | 3 | 0 |
| | | Polyglycerin dodecyl ether (average glycerol condensation degree: 3) | 3 | 0 | 0 | 0 |
| | (e) | Sodium palmitate | 2 | 0 | 0 | 2 |
| | (2f) | Laurylbenzenesulfonic acid sodium salt | 10 | 10 | 10 | 10 |
| | Others | Sodium carbonate | 20 | 20 | 20 | 20 |
| | | zeolite | 15 | 15 | 15 | 15 |
| | | Sodium sulfate | balance | balance | balance | balance |

| | | | | |
|---|---|---|---|---|
| the total | 100 | 100 | 100 | 100 |

| | | | | |
|---|---|---|---|---|
| Generation rate of organic peracid (%) | 71 | 0 | 0 | 20 |
| detergency (%) | 88 | 30 | 30 | 47 |

1. A detergent composition, comprising (a) an inorganic peroxide; (b) a phenylester-type bleaching activator having a group selected from the group consisting of —COOM, —SO₃M and —OSO₃M (M represents a cation) and a hydrocarbon of 5 to 20 carbon atoms in a molecule; and (1d) a polyglyceryl alkyl ether having an alkyl group of 4 to 20 carbon atoms in an amount of more than 5% by mass to 35% by mass.

2. The detergent composition according to claim 1, further comprising (c) a nonionic surfactant having an oxyalkylene group in a molecule.

3. The detergent composition according to claim 1 or 2, wherein the component (b) is a bleaching activator represented by the following formula (b1): 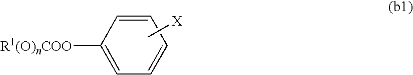
(wherein, R¹ represents a hydrocarbon of 5 to 20 carbon atoms; “n” represents a number of 1 or 0; and, X represents —COOM, —SO₃M or —OSO₃M, M represents a cation.)

4. The detergent composition according to claim 1, wherein the component (1d) is a polyglyceryl alkyl ether having an alkyl group of 4 to 9 carbon atoms.

5. The detergent composition according to claim 1, wherein the component (1d) is a polyglyceryl alkyl ether represented by the following formula (1d1):
R—O—(C₃H₆O₂)ₙ—H (1d1)
(wherein, R represents an alkyl group of 4 to 9 carbon atoms; and, n represents a condensation degree of glycerin, which is a number of 1 to 10 on the average.)

6. The detergent composition according to claim 2, comprising the component (c) in an amount of 5 to 35% by mass.

7. The detergent composition according to claim 1, further comprising (1f) an anion surfactant.

8. A detergent composition comprising: (a) an inorganic peroxide; (b) a phenylester-type bleaching activator having a group selected from the group consisting of —COOM, —SO₃M and —OSO₃M (M represents a cation) and a hydrocarbon of 5 to 20 carbon atoms in a molecule; (2d) a polyglyceryl alkyl ether having an alkyl group of 4 to 20 carbon atoms; and, (e) a fatty acid or a salt thereof.

9. The detergent composition according to claim 8, further comprising (c) a nonionic surfactant having an oxyalkylene group in a molecule.

10. The detergent composition according to claim 8 or 9, wherein the component (b) is a bleaching activator represented by the following formula (b1): 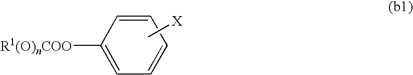
(wherein, R¹ represents a hydrocarbon group of 5 to 20 carbon atoms; “n” represents a number of 1 or 0; and, X represents —COOM, —SO₃M or —OSO₃M, M represents a cation.)

11. The detergent composition according to claim 8, wherein the component (2d) is a polyglyceryl alkyl ether represented by the following formula (2d1):
R—O—(C₃H₆O₂)ₙ—H (2d1)
(wherein, R represents an alkyl group of 6 to 20 carbon atoms; and, n represents a condensation degree of glycerin, which is a number of 1 to 10 on the average.)

12. The detergent composition according to claim 9, comprising the component (c) in an amount of 5 to 35% by mass.

13. The detergent composition according to claim 8, comprising the component (e) in an amount of 0.01 to 20% by mass.

14. The detergent composition according to claim 8, further comprising an anionic surfactant (2f) other than the component (e).
